(19) United States
(12) Patent Application Publication
(10) Pub. No.: US 2022/0070588 A1
(43) Pub. Date: Mar. 3, 2022

(54) DYNAMIC BALANCE SPEAKER

(71) Applicant: HUNG TSE ELECTRIC CO, LTD., Taoyuan City (TW)

(72) Inventor: I-Ching Lu, Taoyuan City (TW)

(21) Appl. No.: 17/118,543

(22) Filed: Dec. 10, 2020

(30) Foreign Application Priority Data
Aug. 26, 2020 (CN) 202021814788.7

(51) Int. Cl. H04R 9/06; H04R 9/02; H04R 1/06; H04R 7/12

(52) U.S. Cl. CPC H04R 9/06; H04R 9/025; H04R 1/06; H04R 2307/027; H04R 2400/11; H04R 2307/025; H04R 2307/029; H04R 7/127

(57) ABSTRACT

A dynamic balance speaker includes a diaphragm, a voice coil, a printed circuit board, a base frame, a first tuning paper, a washer, a main magnet, and a U-yoke. The base frame is formed with a plurality of spaced first vents and a mounting groove in the middle between adjacent two of the first vents. The mounting groove is provided with positioning grooves. The printed circuit board is provided with positioning portions. The positioning portions are fixed in the positioning grooves, respectively. The voice coil is provided with a pair of lead wires. The lead wires are symmetrical to the center of the printed circuit board. The dynamic balance speaker provides good sound quality.

### BACKGROUND OF THE INVENTION

### 1. Field of the Invention

The present invention relates to a speaker, and more particularly to a dynamic balance speaker.

### 2. Description of the Prior Art

With the popularity of MP3 and video players and the widespread use of smart phones, people are increasingly inseparable from earphones when listening to music and watching videos.

Existing headphones usually use micro speakers. A micro speaker generally includes a diaphragm, a voice coil, a support, a tuning paper, a washer, and a magnet. When an electrical signal flows through the voice coil, the energized voice coil is subjected to Ampere force in the magnetic field, which causes the voice coil to vibrate. The vibration of the voice coil drives the diaphragm to vibrate. This vibration converts mechanical energy into sound energy and radiates out a signal. It spreads to the human ear through the action of the air medium. Under normal circumstances, the user can hear the relevant sound information.

Two sides of the voice coil are provided with two lead wires connected to an external circuit, so as to energize the voice coil. But, in this way, the two lead wires are prone to be different in length. In addition, the lead wires need to be glued to the diaphragm, which makes the weights of the voice coil and the diaphragm of the speaker inconsistent. The vibration of the voice coil and the diaphragm is unbalanced, which deteriorates the sound quality of the micro speaker.

Accordingly, the inventor of the present invention has devoted himself based on his many years of practical experiences to solve these problems.

### SUMMARY OF THE INVENTION

The primary object of the present invention is to provide a dynamic balance speaker with good sound quality and balanced voice coil vibration.

In order to achieve the above object, the present invention adopts the following technical solutions:

A dynamic balance speaker comprises a diaphragm, a voice coil, a printed circuit board, a base frame, a first tuning paper, a washer, a main magnet, and a U-yoke. The base frame has a central through hole. The printed circuit board is provided with a pair of signal contacts. A bottom of the base frame is formed with a plurality of spaced first vents and a mounting groove in the middle between adjacent two of the first vents. Left and right sides of the mounting groove are provided with positioning grooves. The printed circuit board is adhered and fixed in the mounting groove. Left and right sides of the printed circuit board are provided with positioning portions. The positioning portions are fixed in the positioning grooves, respectively. The first tuning paper is adhered onto the first vents. Two sides of the voice coil are provided with a pair of lead wires that are arranged symmetrically relative to a center of the voice coil. Free ends of the lead wires are fixedly connected to the signal contacts of the printed circuit board, respectively. The lead wires are symmetrical to a center of the printed circuit board. The diaphragm is disposed above the voice coil. The U-yoke is fixed below the through hole of the base frame. The main magnet is fixed in the U-yoke. The washer is disposed on top of the main magnet. The voice coil surrounds the main magnet and the washer.

Preferably, the dynamic balance speaker further comprises a secondary magnet. The secondary magnet is fixed on top of the washer. The secondary magnet generates a magnetic field with a direction opposite to that of a magnetic field generated by the main magnet.

Preferably, the secondary magnet is partially located above the base frame.

Preferably, an inner side wall of the mounting groove is formed with an inclined guide surface.

Preferably, the bottom of the base frame is formed with a second vent. The second vent is spaced apart from the first vents. A second tuning paper is fixed onto the second vent. The second vent is located close to an inner side of the mounting groove. The second vent is spaced apart from the mounting groove.

Preferably, the second vent is smaller than each of the first vents, and the second tuning paper is smaller than the first tuning paper.

Preferably, the voice coil is a voice coil with a paper core or a hollow voice coil without a paper core.

Preferably, the diaphragm is a composite material of a PU (polyurethane) material and an LCP (liquid crystal polymer) material.

Preferably, the diaphragm is a composite material of a PU material and a biofiber material.

Preferably, the diaphragm is a composite material of a foam material and a fiber material, and the composite material is plated with a metal material.

After adopting the above technical solutions, in the present invention, the bottom of the base frame is formed with the mounting groove, and the printed circuit board is fixed in the mounting groove, and the lead wires of the voice coil are arranged symmetrically relative to the center of the voice coil. The lead wires of the conventional speaker are adhered to the diaphragm by glue. The lead wires of the voice coil of the present invention are in a suspended state, and are fixedly connected to the printed circuit board by welding. The lead wires are symmetrical to the center of the printed circuit board. The printed circuit board is connected with an external circuit. The lead wires exert the same force on the two sides of the voice coil, so that the weight of the voice coil and the diaphragm is balanced and centered, and the vibration of the voice coil and the diaphragm is balanced. The present invention provides a dynamic balance speaker, which realizes consistent up and down vibration. The speaker will not sacrifice the sound effect of different frequencies because of the balanced vibration, so that the sound curve is flat, and the sound quality of the speaker becomes better. In the present invention, through the positioning grooves on the left and right sides of the mounting groove and the positioning portions on the left and right sides of the printed circuit board, the printed circuit board can be quickly positioned in the mounting groove, so as to realize a precise assembly. The printed circuit board will not sway in the mounting groove, so it is convenient to fix the printed circuit board in the mounting groove by glue.

### BRIEF DESCRIPTION OF THE DRAWINGS

FIG. 1 is an exploded view of the present invention;

FIG. 2 is a cross-sectional view of the present invention; and

FIG. 3 is a rear view of FIG. 1 after being assembled.

### DETAILED DESCRIPTION OF THE PREFERRED EMBODIMENTS

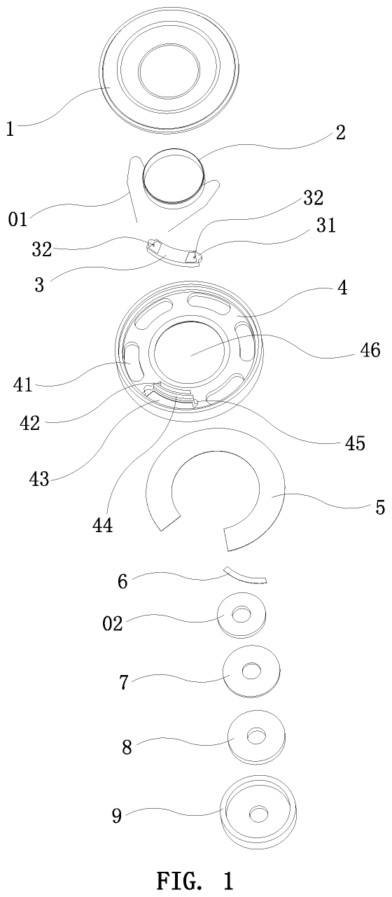

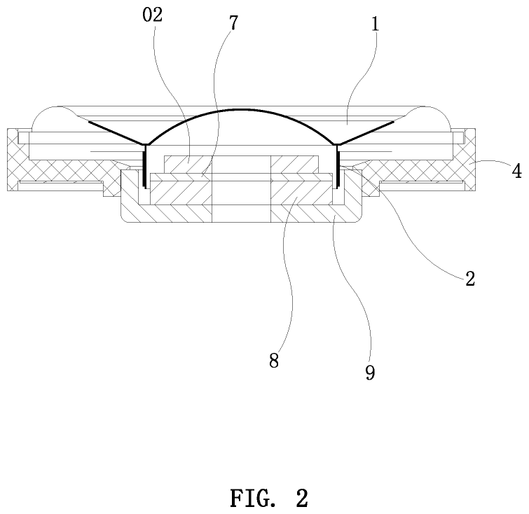

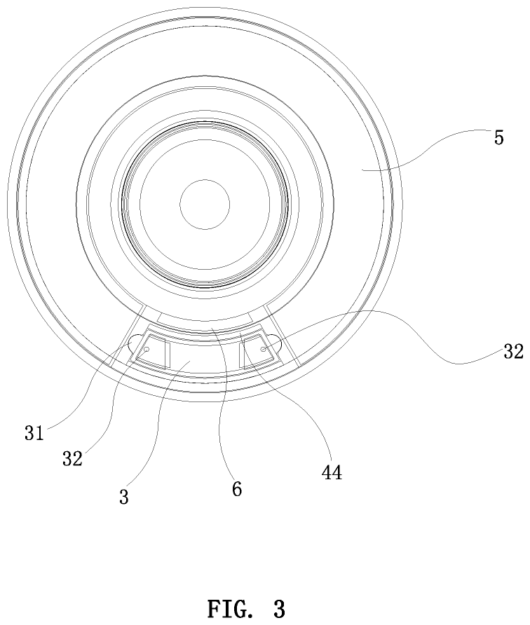

Referring to FIG. 1 through FIG. 3, the present invention discloses a dynamic balance speaker, comprising a diaphragm 1, a voice coil 2, a printed circuit board 3, a base frame 4, a first tuning paper 5, a washer 7, a main magnet 8, and a U-yoke 9. The base frame 4 has a central through hole 46. The printed circuit board 3 is provided with a pair of signal contacts 32. The bottom of the base frame 4 is formed with a plurality of spaced first vents 41 and a mounting groove 43 in the middle between adjacent two of the first vents 41. The left and right sides of the mounting groove 43 are provided with positioning grooves 45. The printed circuit board 3 is adhered and fixed in the mounting groove 43. The left and right sides of the printed circuit board 3 are provided with positioning portions 31. The positioning portions 31 are fixed in the positioning grooves 45, respectively. The first tuning paper 5 is adhered onto the first vents 41. In other words, the first tuning paper 5 covers the plurality of first vents 41 and is attached to the underside of the base frame 4 outside the first vents 41. Two sides of the voice coil 2 are provided with a pair of lead wires 01 that are arranged symmetrically relative to the center of the voice coil 2. The free ends of the lead wires 01 are fixedly connected to the signal contacts 32 on the inner side of the printed circuit board 3 by welding, respectively. The lead wires 01 are symmetrical to the center of the printed circuit board 3. The diaphragm 1 is disposed above the voice coil 2. The U-yoke 9 is fixed below the through hole 46 of the base frame 4. The main magnet 8 is fixed in the U-yoke 9. The washer 7 is disposed on top of the main magnet 8. The voice coil 2 surrounds the main magnet 8 and the washer 7. The lead wires 01 may be in a curved state to be in contact with the suspended arc-shaped edge of the diaphragm 1.

Therefore, in the present invention, the bottom of the base frame 4 is formed with the mounting groove 43, and the printed circuit board 3 is fixed in the mounting groove 43, and the lead wires 01 of the voice coil 2 are arranged symmetrically relative to the center of the voice coil 2. The lead wires of the conventional speaker are suspended and adhered on the diaphragm 1 by glue. The lead wires 01 of the voice coil 2 of the present invention are in a suspended state, and are fixedly connected to the printed circuit board 3 by welding. The lead wires 01 are symmetrical to the center of the printed circuit board 3. The printed circuit board 3 is connected with an external circuit. The lead wires 01 exert the same force on the two sides of the voice coil 2, so that the weight of the voice coil 2 and the diaphragm 1 is balanced and centered, and the vibration of the voice coil 2 and the diaphragm 1 is balanced. The present invention provides a dynamic balance speaker, which realizes consistent up and down vibration. The speaker will not sacrifice the sound effect of different frequencies because of the balanced vibration, so that the sound curve is flat, and the sound quality of the speaker becomes better. In the present invention, through the positioning grooves 45 on the left and right sides of the mounting groove 43 and the positioning portions 31 on the left and right sides of the printed circuit board 3, the printed circuit board 3 can be quickly positioned in the mounting groove 43, so as to realize a precise assembly. The printed circuit board 3 will not sway in the mounting groove 43, so it is convenient to fix the printed circuit board 3 in the mounting groove 43 by glue. The lead wires 01 are suspended between the diaphragm 1 and the base frame 4, so that the diaphragm 1 and the lead wires 01 can be independently vibrated synchronously but not interfere with each other. The vibration of the diaphragm 1 is more balanced, which is beneficial for the normal output of signals and realizes a high-fidelity signal output. In the conventional speaker, the printed circuit board is fixed to the support by glue, and the printed circuit board is easy to loosen due to vibration, causing vibration interference. Through the cooperation of the positioning portions 31 and the positioning grooves 45, the printed circuit board 3 of the speaker provided by the present invention is finnly adhered in the mounting groove 43, so that the printed circuit board 3 and the base frame 4 are connected as a whole without vibration interference.

Furthermore, the present invention may include a secondary magnet 02. The secondary magnet 02 is fixed on top of the washer 7. The direction of the magnetic field of the secondary magnet 02 is opposite to the direction of the magnetic field of the main magnet 8, so that the secondary magnet 02 and the main magnet 8 are mutually exclusive. The arrangement of the secondary magnet 02 increases the strength of the magnetic field and increases the spread of the magnetic field. According to Fleming's left-hand rule, the Ampere force received by the energized voice coil 2 increases, which increases the vibration of the voice coil 2 and diaphragm 1. In cooperation with the first vents 41 and the second vent 42, the first tuning paper 5 and the second tuning paper 6 vibrate up and down evenly, so that the diaphragm 1 vibrates up and down more evenly. The structure of the conventional speaker is limited, and it is difficult to increase the strength of the magnetic field. In the speaker provided by the present invention, the secondary magnet 02 and the main magnet 8 form mutual repulsion, so that the force received by the voice coil 2 is increased, and the reaction force of the voice coil 2 on the diaphragm 1 is increased, and the sound quality produced by the speaker of the present invention is better, and the frequency curve of SPL (Sound Pressure Level) of the speaker of the present invention has better performance. The secondary magnet 02 may be partially located above the base frame 4.

Furthermore, in order to facilitate the filling of glue, the inner side wall of the mounting groove 43 is formed with an inclined guide surface 44. The inclined guide surface 44 is inclined from the inside to the outside, so that the glue can quickly enter the mounting groove 43 along the inclined guide surface 44 for the printed circuit board 3 to be fixed in the mounting groove 43.

Furthermore, the bottom of the base frame 4 may be formed with a second vent 42. The second vent is spaced apart from the first vents 41. A second tuning paper 6 is fixed onto the second vent 42. The second vent 42 is located close to the inner side of the mounting groove 43. The second vent 42 is spaced apart from the mounting groove 43. The second vent 42 is located between the through hole 46 and the mounting groove 43. The first vents 41 and the second vent 42 are arranged at even intervals, so that the vibration of the voice coil 2 is balanced.

Furthermore, the second vent 42 may be smaller than the first vent 41. The second tuning paper 6 may be smaller than the first tuning paper 5 to reduce the cost.

The voice coil 2 may be a voice coil with a paper core or a hollow voice coil without a paper core. The diaphragm 1 may be a composite material of a PU (polyurethane) material and an LCP (liquid crystal polymer) material. The diaphragm 1 may be a composite material of a PU material and a biofiber material, but not limited thereto. The voice coil 2 may adopt other types. The diaphragm 1 may adopt other single-layer or multi-layer sound diaphragm materials. The diaphragm 1 may be a composite material of a foam material and a fiber material. The composite material is plated with a metal material. For example, the diaphragm 1 may be made of a PET material, PET and PU composite material, PEEK and PU composite material, two PEEK materials bonded by glue, or PEEK, PU and PEEK materials bonded in sequence. The glue may be PAR acrylic glue or silicone glue. The diaphragm 1 may be plated with metallic beryllium, metallic titanium, graphite metal, metallic nickel or diamond-like carbon by electroplating. If the hardness of the material is not hard enough, aluminum foil, or aluminum-magnesium alloy metal materials and carbon fiber diaphragm materials, bio-fibers, or other metal or plastic foam materials can be used. The suspended edge is made of a composite material, such as PET, PEN, PEI, PEEK, PU, and TPEE.

The circumferential edge of the diaphragm 1 is adhered to the annular step formed on the top of the inner wall of the base frame 4. A vibration gap for reciprocating the voice coil 2 is formed between the U-yoke 9 and the base frame 4. The voice coil 2 is sleeved onto the secondary magnet 02, the washer 7 and the main magnet 8.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A dynamic balance speaker, comprising a diaphragm, a voice coil, a printed circuit board, a base frame, a first tuning paper, a washer, a main magnet and a U-yoke, the base frame having a central through hole, the printed circuit board being provided with a pair of signal contacts;
a bottom of the base frame being formed with a plurality of spaced first vents and a mounting groove in the middle between adjacent two of the first vents, left and right sides of the mounting groove being provided with positioning grooves, the printed circuit board being adhered and fixed in the mounting groove, left and right sides of the printed circuit board being provided with positioning portions, the positioning portions being fixed in the positioning grooves respectively, the first tuning paper being adhered onto the first vents, two sides of the voice coil being provided with a pair of lead wires that are arranged symmetrically relative to a center of the voice coil, free ends of the lead wires being fixedly connected to the signal contacts of the printed circuit board respectively, the lead wires being symmetrical to a center of the printed circuit board;
the diaphragm being disposed above the voice coil, the U-yoke being fixed below the through hole of the base frame, the main magnet being fixed in the U-yoke, the washer being disposed on top of the main magnet, the voice coil surrounding the main magnet and the washer.

2. The dynamic balance speaker as claimed in claim 1, further comprising a secondary magnet, the secondary magnet being fixed on top of the washer, the secondary magnet generating a magnetic field with a direction opposite to that of a magnetic field generated by the main magnet.

3. The dynamic balance speaker as claimed in claim 2, wherein the bottom of the base frame is formed with a second vent, the second vent is spaced apart from the first vents, a second tuning paper is fixed onto the second vent, the second vent is located close to an inner side of the mounting groove, and the second vent is spaced apart from the mounting groove.

4. The dynamic balance speaker as claimed in claim 3, wherein the second vent is smaller than each of the first vents, and the second tuning paper is smaller than the first tuning paper.

5. The dynamic balance speaker as claimed in claim 2, wherein the secondary magnet is partially located above the base frame.

6. The dynamic balance speaker as claimed in claim 5, wherein the bottom of the base frame is formed with a second vent, the second vent is spaced apart from the first vents, a second tuning paper is fixed onto the second vent, the second vent is located close to an inner side of the mounting groove, and the second vent is spaced apart from the mounting groove.

7. The dynamic balance speaker as claimed in claim 6, wherein the second vent is smaller than each of the first vents, and the second tuning paper is smaller than the first tuning paper.

8. The dynamic balance speaker as claimed in claim 1, wherein an inner side wall of the mounting groove is formed with an inclined guide surface.

9. The dynamic balance speaker as claimed in claim 8, wherein the bottom of the base frame is formed with a second vent, the second vent is spaced apart from the first vents, a second tuning paper is fixed onto the second vent, the second vent is located close to an inner side of the mounting groove, and the second vent is spaced apart from the mounting groove.

10. The dynamic balance speaker as claimed in claim 9, wherein the second vent is smaller than each of the first vents, and the second tuning paper is smaller than the first tuning paper.

11. The dynamic balance speaker as claimed in claim 1, wherein the bottom of the base frame is formed with a second vent, the second vent is spaced apart from the first vents, a second tuning paper is fixed onto the second vent, the second vent is located close to an inner side of the mounting groove, and the second vent is spaced apart from the mounting groove.

12. The dynamic balance speaker as claimed in claim 11, wherein the second vent is smaller than each of the first vents, and the second tuning paper is smaller than the first tuning paper.

13. The dynamic balance speaker as claimed in claim 1, wherein the voice coil is a voice coil with a paper core or a hollow voice coil without a paper core.

14. The dynamic balance speaker as claimed in claim 1, wherein the diaphragm is a composite material of a PU (polyurethane) material and an LCP (liquid crystal polymer) material.

15. The dynamic balance speaker as claimed in claim 1, wherein the diaphragm is a composite material of a PU material and a biofiber material.

16. The dynamic balance speaker as claimed in claim 1, wherein the diaphragm is a composite material of a foam material and a fiber material, and the composite material is plated with a metal material.
